(19) United States
(12) Patent Application Publication
(10) Pub. No.: US 2012/0122730 A1
(43) Pub. Date: May 17, 2012

(54) Methods for Quantitative Analyses of Kinase Inhibitor Selectivity Using Small Size Panels

(76) Inventor: Quoc-Nam Tran, Beaumont, TX (US)

(21) Appl. No.: 13/295,635

(22) Filed: Nov. 14, 2011

Related U.S. Application Data
(60) Provisional application No. 61/413,809, filed on Nov. 15, 2010.

(51) Int. Cl. C40B 30/08

(52) U.S. Cl. 506/11

(57) ABSTRACT

Methods for analyses of kinase inhibitor specificity and promiscuity using small subsets of kinases including a method comprising providing a set of kinases, ranking the kinases based upon their ability to overcome biases, utilizing a correlation-based feature selection algorithm to select a kinase inferential bases, and screening a kinase inhibitor against the kinase inferential bases.

### CROSS-REFERENCE TO RELATED APPLICATIONS

This application claims the benefit of U.S. Provisional Patent Application Ser. No. 61/413,809 filed Nov. 15, 2010, the entire disclosure of which is incorporated by reference.

### BACKGROUND

Protein kinases are enzymes that modify other proteins by chemically adding phosphate groups to them. This process, called phosphorylation, usually results in a functional change of the target protein (also known as the substrate) by changing enzyme activity, cellular location, or association characteristics with other proteins. Kinases are known to regulate the majority of cellular pathways, especially those involved in signal transduction. By modification of substrate activity, protein kinases also control many other cellular processes, including metabolism, transcription, cell cycle progression, cytoskeletal rearrangement, and cell movement, apoptosis, and differentiation. Protein phosphorylation also plays a critical role in intercellular communication during development, in physiological responses, and in homeostasis and in the functioning of the nervous and immune systems. Because protein kinases have profound effects on a cell, and because of their central role in cellular processes, the number of kinases with potential as drug targets is significant. Kinases have been implicated as drug targets not only in the treatment of cancer, but also in a number of non-oncology indications, including central nervous system disorders, autoimmune disease, post-transplant immunosuppression, osteoporosis, and metabolic disorders. Kinase inhibitors are molecules that bind to enzymes and decrease their activity. Since blocking an enzyme's activity can kill a pathogen or correct a metabolic imbalance, many drugs are kinase inhibitors.

To fully explore and exploit this opportunity of targeting kinases as drug targets, potent and selective inhibitors are required for a multitude of kinases, both as tool compounds for target validation and as leads for drug development. Kinase-inhibitor discovery has been a mainly linear process that addresses one kinase at a time and requires significant investment of time and resources for each target. In this resource-intensive and time-consuming process, an inhibitor is screened against a large size panel of kinases, typically 500 or more, to identify hits that often have weak or modest potency. Kinase selectivity is typically assessed on only a subset of the screening hits, and is monitored only at the end of the process. This strategy has significant drawbacks. First, targets are addressed one at a time, and the entire process has to be repeated for each new target of interest. Second, decisions about which targets to pursue are based on biology alone, with minimal knowledge about the availability or quality of hits against the designated target in the available chemical library.

As the heterogeneous nature of cancer is delineated, the focus of molecular therapy is shifting progressively towards multi-target drugs. In the treatment of tumors, scientists are advocating molecular therapies based on a multi-pronged attacks. For example, drug-based interference with several signaling pathways provides a multi-pronged attack that is proving more effective than single-pronged “magic bullet” attacks in hampering development and progression of malignancy. Such therapeutic agents typically target the kinases, thus blocking or interfering with signaling pathways that control cell fate and proliferation.

Small molecule kinase inhibitors are a new class of drug with a tendency to inhibit multiple targets. This new class of drug will grow remarkably as the large number of compounds currently in preclinical and clinical development progress towards the market. However, because kinases share common evolutionary backgrounds, they also share structural attributes, making it difficult for drugs to tell apart paralogs of clinical importance from off-target kinases. Thus, multi-target kinase inhibitors tend to have undesired cross-reactivities with potentially lethal or debilitating side effects. The issue of multi-target therapy has lead to the requirement of analyzing the promiscuity or specificity of kinase inhibitors. A pressing issue exists of which type of clinical impact can only be achieved with a promiscuous drug, and conversely, which clinical effect lends itself to drug specificity.

Of central clinical importance in this regard is the issue of whether the desired clinical impact is likely to promote side effects or may be achieved by drugs endowed with high specificity. Currently, compounds must be screened against a large number of kinases in order to obtain an accurate indication of specificity and promiscuity. As this is a time consuming process, methods for determining specificity and promiscuity by screening compounds against fewer kinases are highly desirable.

### SUMMARY

The present disclosure generally relates to methods and the small size panels that come about as consequences for quantitative analyses of kinase inhibitor selectivity and promiscuity. More particularly, the present disclosure relates to methods for analyses of kinase inhibitor specificity and promiscuity using small subsets of kinases.

In one embodiment, the present disclosure provides a method comprising: providing a set of kinases, ranking the kinases based upon their ability to overcome biases, utilizing a correlation-based feature selection algorithm to select a kinase inferential bases, and screening a kinase inhibitor against the kinase inferential bases.

In another embodiment, the present disclosure provides a method comprising: screening a kinase inhibitor against a kinase inferential bases.

In another embodiment, the present disclosure provides a method for determining a kinase inferential bases.

In another embodiment, the present disclosure provides a kinase inferential bases.

The features and advantages of the present disclosure will be apparent to those skilled in the art. While numerous changes may be made by those skilled in the art, such changes are within the spirit of the invention.

### DRAWINGS

Some specific example embodiments of the disclosure may be understood by referring, in part, to the following description and the accompanying drawings.

FIG. 1 depicts kinase interaction maps for selective and promiscuous inhibitors.

FIG. 2 is a graph of Lorenz curves in which The Equality Line (Eq) is defined based on the percentages of elements in |C₁|, |C_{1 . . . 2}|=|C₁+|C₂|, . . . ; |C_{1 . . . n}|=Σᵢ₌₁ⁿ|Cᵢ|, at x-coordinates 0,1/n,2/n, . . . , 1 where n is the number of classes and |C₁|≧|C₂|≦ . . . ≦|Cₙ|. The Lorenz polygon L(Rⱼ) of a partition, say Rⱼ, is defined based on the percentage of elements in

$$\vert {C}_{1}^{j} \vert , \vert {C}_{1}^{j} \vert + \vert {C}_{2}^{j} \vert , … , {\sum }_{i = 1}^{n} \vert {C}_{i}^{j} \vert$$

at x-coordinates 0,1/n,2/n, . . . , 1. The Gini coefficient of a partition, say Rⱼ, is defined as (∫₀¹L(Rⱼ)·dx−∫₀¹Eq·dx/∫₀¹ Eq·dx. One can easily see that the partitions with different class orders are now differentiated.

FIG. 3A is a graph showing accuracy of predicting the specificity or promiscuity when the kinase bases consisted of five kinases AMPK-alpha1, FGR, FLT3(D835H), LOK, GAK were used under different k-fold validation schemes. The average accuracy (AVG) is 100%.

FIG. 3B is a graph showing accuracy of predicting the specificity or promiscuity when 10 random subsets (Rand_i, i=1 . . . 10) each containing 5 randomly chosen kinases were used under different k-fold validation schemes. The average accuracy (AVG) is 52%.

FIG. 4 is a graph showing accuracy of predicting the specificity or promiscuity when the three kinase bases consisted of five kinases were used under different k-fold validation schemes. The average accuracy (AVG) is ˜97.3%. Basis 4-1 consisted of FGFR2, GAK, LOK, and MAP4K5. Basis 4-2 consisted of FGR, FLT3(D835H), GAK, and LOK. Basis 4-3 consisted of AMPK-alpha1, FGR, GAK, and LOK.

FIG. 5 is a graph showing accuracy of predicting the specificity or promiscuity when the three kinase bases consisted of five kinases were used under different k-fold validation schemes. The average accuracy (AVG) is ˜95%. Basis 3-1 consisted of GAK, LOK, and MAP4K5. Basis 3-2 consisted of FGFR2, GAK, and LOK. Basis 3-3 consisted of FGFR2, GAK, and MAP4K5.

FIG. 6A is a graph showing accuracy of predicting the specificity or promiscuity when the kinase bases consisted of two kinases GAK, and MAP4K5 were used under different k-fold validation schemes. The average accuracy (AVG) is 89.2% accuracy. 6B are graphs depicting the accuracy for predicting specificity or promiscuity of kinase inhibitors based upon kinase subsets.

FIG. 6B is a graph showing accuracy of predicting the specificity or promiscuity when 10 random subsets (Rand_i, i=1 . . . 10) each containing 300 randomly chosen kinases were used. The average accuracy (AVG) is ˜75%.

FIG. 7 is a chart depicting the weighted selectivity scores and classes of certain kinase inhibitors. cl-P means the inhibitor is classified as Promiscuous. cl-S means the inhibitor is classified as Specific. cl-N means the inhibitor is classified as neither promiscuous nor specific.

FIG. 8 is a chart listing 85 highest ranking kinases with respect to the weighted selectivity scores.

FIG. 9 is a graph showing accuracy of predicting the specificity or promiscuity when 10 random subsets (Rand_i, i=1 . . . 10) each containing 10 randomly chosen kinases were used. The average accuracy (AVG) is ˜60%.

FIG. 10 is a graph showing accuracy of predicting the specificity or promiscuity when 10 random subsets (Rand_i, i=1 . . . 10) each containing 100 randomly chosen kinases were used. The average accuracy (AVG) is ˜70%.

FIG. 11 is a graph showing accuracy of predicting the specificity or promiscuity when 10 random subsets (Rand_i, i=1 . . . 10) each containing 200 randomly chosen kinases were used. The average accuracy (AVG) is ˜74%.

FIG. 12 is a chart depicting a Bayesian network (BN) predictive model for 5 kinases GAK, LOK, FLT3 (D835H), FGR, and AMPK-α1.

While the present disclosure is susceptible to various modifications and alternative forms, specific example embodiments have been shown in the figures and are herein described in more detail. It should be understood, however, that the description of specific example embodiments is not intended to limit the invention to the particular forms disclosed, but on the contrary, this disclosure is to cover all modifications and equivalents as illustrated, in part, by the appended claims.

### DESCRIPTION

The present disclosure generally relates to methods for quantitative analyses of kinase inhibitor selectivity and promiscuity. More particularly, the present disclosure relates to methods for analyses of kinase inhibitor selectivity and promiscuity using small subsets of kinases.

The present disclosure is based, at least in part, on the discovery that by machine learning techniques, kinase inhibitor specificity or promiscuity can be decided with up to 100% accuracy by examining the affinities of the kinase inhibitor towards a small set of kinases. Accordingly, the methods of the present disclosure do not require the screening of all kinases in an organism's genome, but instead may be determined by a few specific hits. Hence, the methods of the present disclosure can reduce screening costs for certain drugs by up to 90%.

In one embodiment, the present disclosure relates to methods of predicting the specificity or promiscuity of a kinase inhibitor comprising determining a kinase subset, also known as “a kinase inferential bases,” and screening the kinase inhibitor against the kinase subset.

In one embodiment, a kinase subset may be determined by using a computational method that can extract knowledge from large amounts of data from known cancer drug designs and find a subset of kinases. A first step in determining a kinase subset involves the use of data from competition binding assays where kinase inhibitors are evaluated against a panel of protein kinases. For each interaction, a quantitative dissociation constant (K_{d}) is needed.

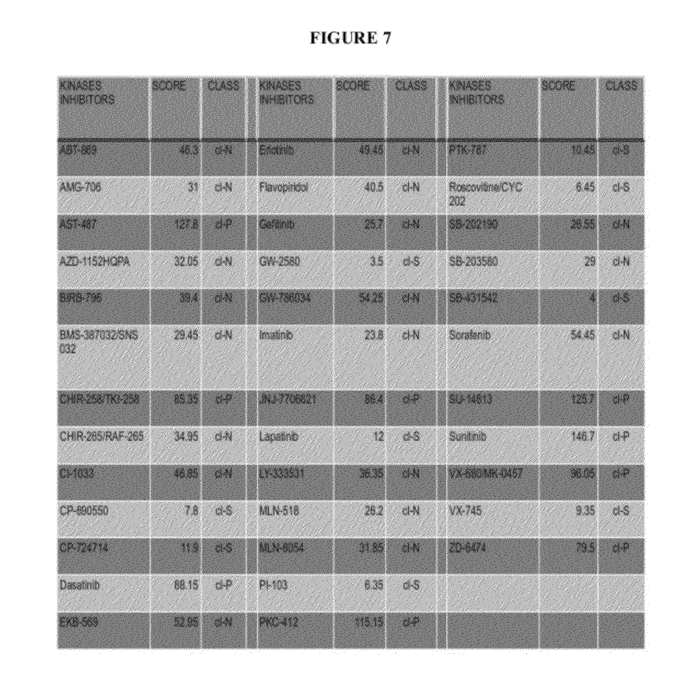

In one embodiment, a quantitative description, called a weighted selectivity score, is developed for assessing kinome-wide compound reactivities by suitably coarse-graining the binding-affinity vector. The reasons for introducing the weighted selectivity scores are two-fold: (1) even though ligand-kinase interaction maps can provide a useful graphic overview of how compounds interact with the kinome, these maps provide only a qualitative overall measure of selectivity and (2) selectivity scores calculated by counting the number of binding interactions with K_{d} less than a threshold constant such as 3 μM divided by the number of kinases tested do not represent all the information about the strength of the binding interactions. In one embodiment, three main binding thresholds (100 nM, 1 and 3 μM) are adopted. Kinsases found to bind with a dissociation constant <100 nM may be given an individual weight of 1.0. Similarly, kinases found to bind with a dissociation constant <1 μM and <3 μM will be given an individual weight of 0.75 and 6.6, respectively. While inferential accuracy may be maintained within some latitude in the selection of individual weights, these choices respond to the need to maintain the coherency of multiple binds vis a vis the compound score. For instance, two bindings with dissociation constants <1 μM should yield a lower compound score than two bindings with dissociation constants <100 nM but higher than three bindings with dissociation constants <3 μM. The weighted selectivity score (normalized or not) is an unbiased measure that enables quantitative comparisons between compounds and the detailed differentiation and analysis of interaction patterns. FIG. 7 lists the overall scores of several kinase inhibitors, based upon the weighted selectively scores. For example, scores ranged from 3.5 for GW-2580 to 146.7 for Sunitinib.

Once a weighted selectivity score for a particular kinase inhibitor has been determined, the kinase inhibitor may then be classified into one of three selectivity classes, representing specificity (class A), promiscuity (class B), or neither specificity nor promiscuity (class C), based upon the weighted selectivity score. The selectivity scores of kinase inhibitors are assumed to be generated by a sequence of probability distributions in which each distribution generates one class. Since the distribution parameters such as mean, standard deviation, and probability for the three selectivity classes are not known, an Expectation-Maximization (EM) algorithm may be used to find these unknown probability distributions.

The first step is to begin with the guess estimate of the distribution parameters for each class:
μ_{A}⁰,δ_{A}⁰,p_{A}⁰,μ_{B}⁰,δ_{B}⁰,p_{B}⁰,μ_{C}⁰,δ_{C}⁰,p_{C}⁰.
   The next step is to compute the expected values. At each iteration j, the probability that the data object x belongs to class A, B, or C can be calculated by using the following formulas:

$$P ( A \vert x ) = \frac{{p}_{A}^{j} {P}^{j} ( x \vert A )}{{P}^{j} ( x )} , P ( B \vert x ) = \frac{{p}_{B}^{j} {P}^{j} ( x \vert B )}{{P}^{j} ( x )} , \\ P ( C \vert x ) = \frac{{p}_{C}^{j} {P}^{j} ( x \vert C )}{{P}^{j} ( x )} .$$

The mixture parameters may then be updated based on the new estimate using the following formulas:

$${p}_{A}^{j} = \frac{1}{n} \sum P ( A \vert x ) , {p}_{B}^{j + 1} = \frac{1}{n} \sum P ( B \vert x )$$

$${p}_{C}^{j + 1} = \frac{1}{n} \sum P ( C \vert x )$$

$${μ}_{A}^{j + 1} = \frac{\sum x P ( A \vert x )}{\sum P ( A \vert x )} , {μ}_{B}^{j + 1} = \frac{\sum x P ( B \vert x ) }{\sum P ( B \vert x )} , \\ {μ}_{C}^{j + 1} = \frac{\sum x P ( C \vert x )}{\sum P ( C \vert x )} , \\ {σ}_{A}^{j + 1} = \frac{\sum P ( A \vert x ) {( x - {μ}_{A}^{j + 1} )}^{2}}{\sum P ( A \vert x )} , {σ}_{B}^{j + 1} = \frac{\sum P ( B \vert x ) {( x - {μ}_{B}^{j + 1} )}^{2} }{\sum P ( B \vert x )} , \\ {σ}_{C}^{j + 1} = \frac{\sum P ( C \vert x ) {( x - {μ}_{C}^{j + 1} )}^{2}}{\sum P ( C \vert x )} ,$$

The log estimate may then be computed using the following formula:

Eⱼ=Σ log(P^{j}(x))

If some fixed stopping condition ε, |Eⱼ−Eⱼ₊₁|≦ε, the stop; otherwise j←j+1.

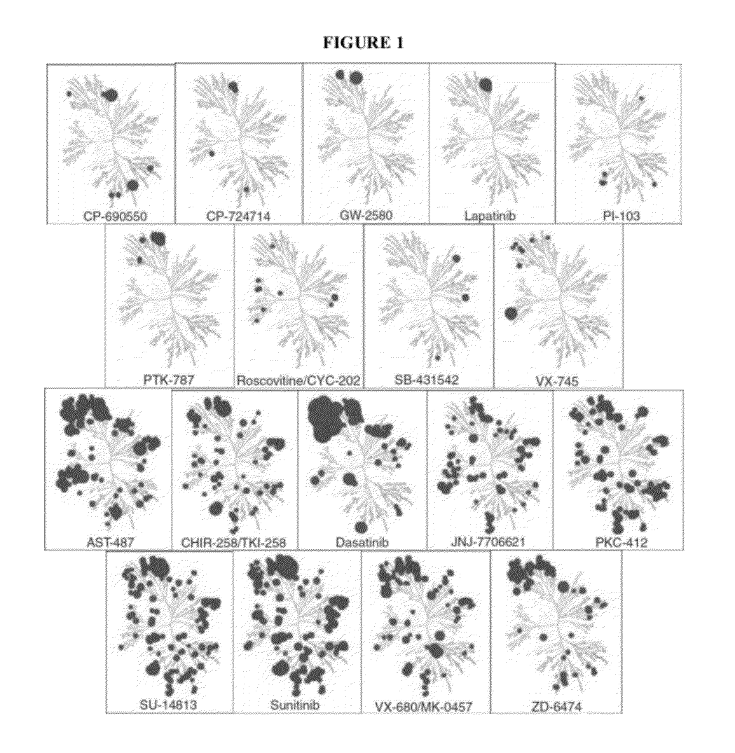

By using the Expectation-Maximization algorithm, it has been found that the continuous selectivity scores can be partitioned into three classes: one class with roughly 25% of inhibitors that are highly specific, one class with roughly 25% of inhibitors that are highly promiscuous, and one class for the remaining inhibitors, which are not specific nor promiscuous. Each class is represented by a range of the weighted selectivity scores. FIG. 1 shows the kinase interaction maps of inhibitors in the highly specific class and inhibitors in the highly promiscuous class. FIG. 7 contains a list of kinase inhibitors together with their selectivity scores and classes.

The use of the Expectation-Maximization algorithm presents several advantages. For example, if samples were taken from a distribution of class A with probability p and a distribution of class B with probability 1−p, it would be relatively easy to compute the maximum likelihood estimates for the parameters of each normal distribution (the sample mean and variance of the points sampled from A and B respectively) and the mixing probability p if it were noted of which class generated each sample. However, since it would not be known how to partition the set of scores in a statistically meaningful way for accurate inference of promiscuity/specificity, it would not be known which class a particular data point should belong to, nor the parameters of the class distributions. The use of the Expectation-Maximization algorithm solves this problem.

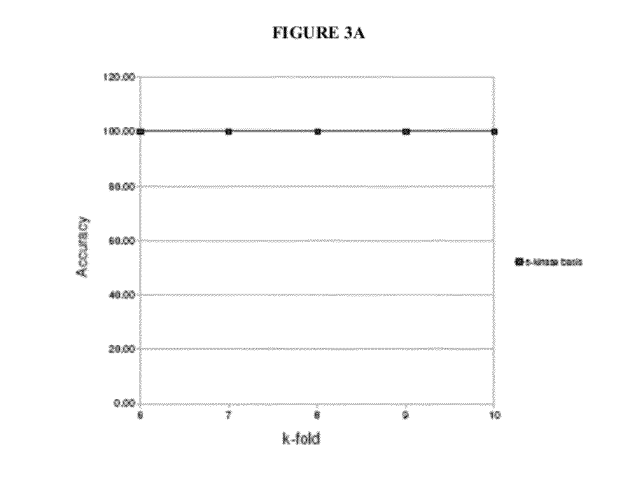

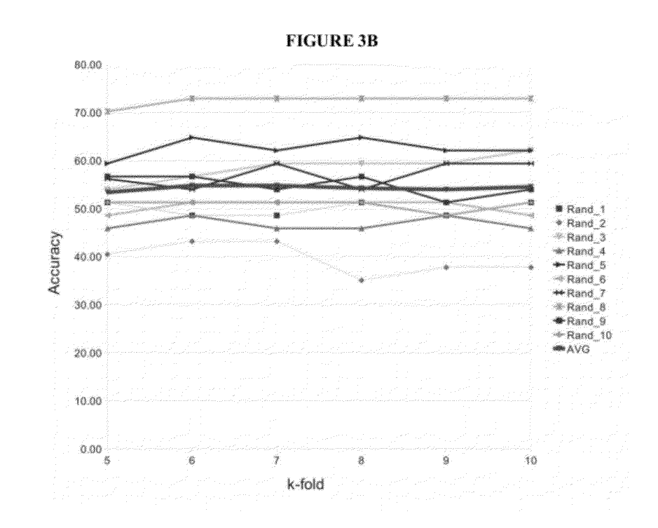

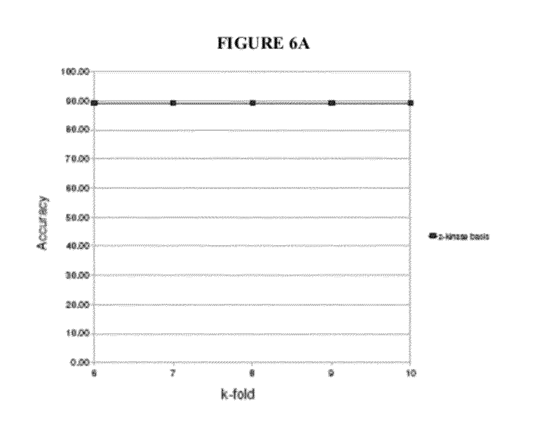

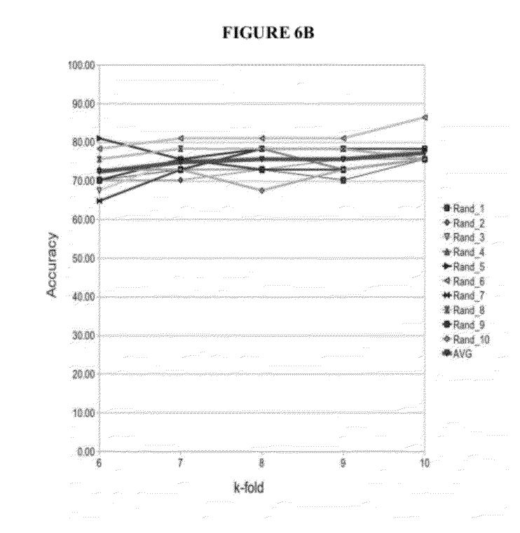

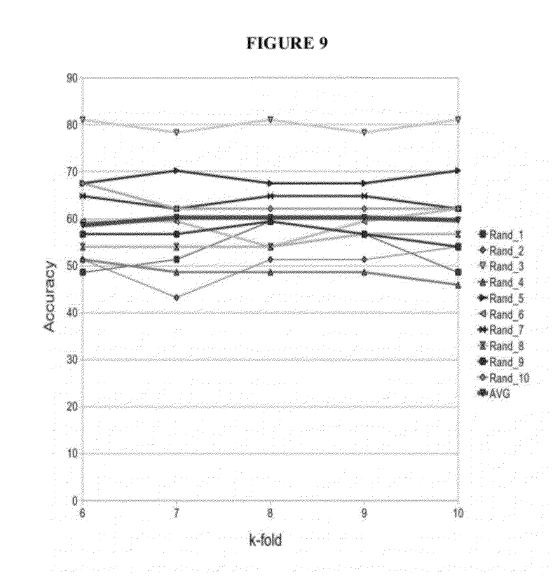

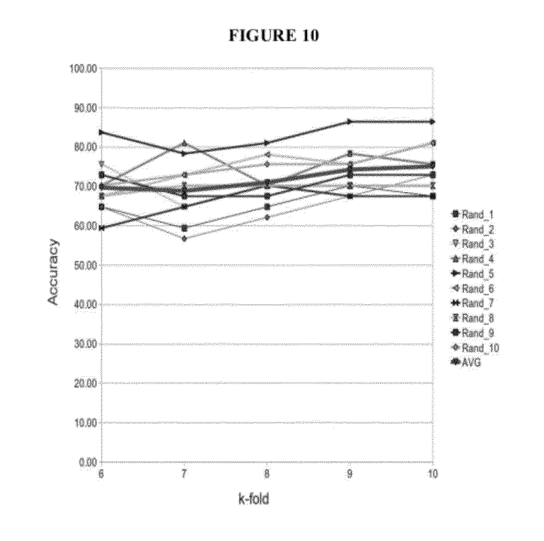

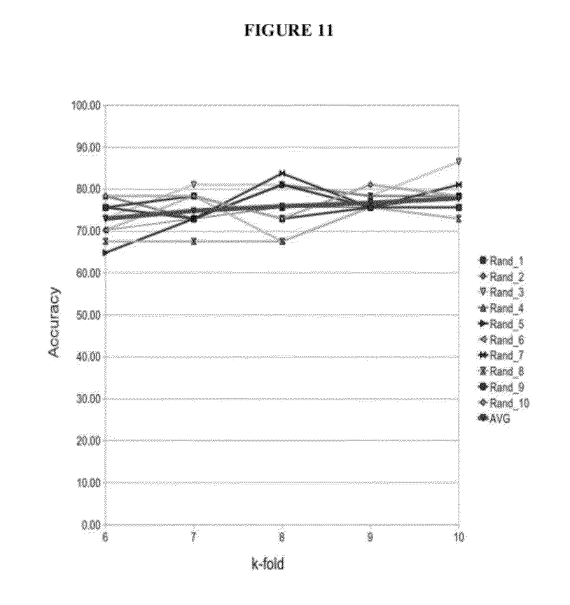

Once a kinase inhibitor has been placed into a selectivity class, a kinase inferential bases may be determined. A straightforward approach that evaluates all possible subsets of kinases and finds the smallest one with the highest predictive accuracy would be an impossible task even for a computer, as there are currently 2³¹⁷ (or approximately 2.7×10⁹⁵) subsets to evaluate. Accordingly, as recognized by the methods of the present disclosure, a better approach for finding a target universe is to determine which kinases are crucial in deciding the selectivity of inhibitors. It has been found that not all kinases are equally crucial in deciding the selectivity of inhibitors. Furthermore, randomly chosen subsets of kinases may not give an accurate measure of selectivity. FIGS. 3 and 6 demonstrate the accuracy for predicting specificity or promiscuity of 10 random subsets with 5 and 300 randomly chosen kinases, respectively. FIGS. 9-11 demonstrate the accuracy for predicting specificity or promiscuity of random subsets of 10, 100, and 200 kinases. Furthermore, naive use of machine learning techniques for predicting the selectivity of a kinase inhibitor also may yield an unsatisfactory result because (a) an inhibitor still has to be screened against almost the whole set of kinases and (b) the accuracy for the prediction is not high.

To improve the accuracy, in one embodiment of the present disclosure, a Gini-based method for ranking the kinases due to its ability to overcome biases may be used. In one embodiment of the present invention, a Gini, index of a kinase A, with values of binding infinity of inhibitors discretized into ranges Rₗ . . . Rₘ, may be calculated as in formula 1 below:

$${gini}_{A} ( D ) = {\sum }_{i = 1}^{m} \frac{\vert {R}_{i} \vert}{d} \cdot gini ( {R}_{i} ) , \\ wherein \text{:}$$

$$gini ( {R}_{i} ) = 1 - {\sum }_{j = 1}^{g} {p}_{i , j}^{2} , \\ and wherein \text{:}$$

$${p}_{i , j} = \frac{\vert {C}_{i , j} \vert}{\vert {R}_{i} \vert}$$

is the relative frequency of class Cⱼ in Rᵢ.

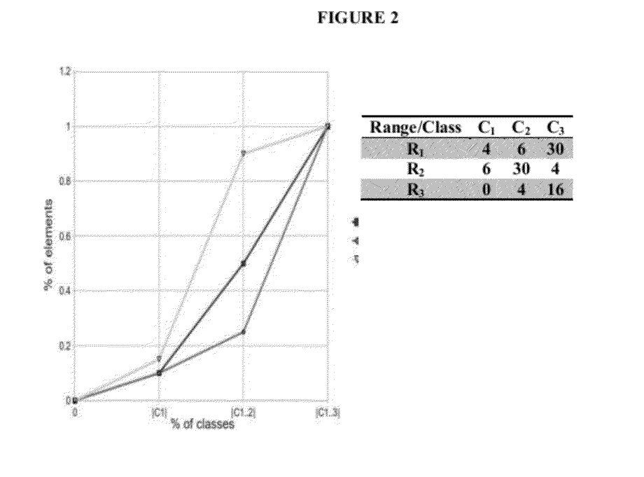

It is well known that Gini index has biases due to the order of classes and the order of ranges during the calculation steps. In one embodiment, in order to compensate for these biases, the use of Lorenz curves, a common measure in economics to gauge the inequalities in income and wealth, may be applied. FIG. 2 illustrates how modified Lorenz curves and modified Gini coefficients may be calculated. The Equality Line (Eq) may be defined based on the percentages of elements in the following formula

|C₁|,|C_{1 . . . 2}|=|C₁|+|C₂|, . . . ,|C_{1 . . . n}|=Σᵢ₌₁ⁿ|Cᵢ|

at x-coordinates 1, 1/n, 2/n, . . . , 1, where n is the number of classes and |C₁|≦|C₂|≦, . . . , ≦|Cₙ|.

The Lorenz curve of a range, for example may be defined based on the following formula

|C₁^{j}|,C₁^{j}|+|C₂^{j}|, . . . ,Σᵢ₌₁ⁿ|Cᵢ^{j}|

at x-coordinates 1, 1/n, 2/n, . . . , 1.

The Gini as coefficient of a range, say Rⱼ, may be defined based upon the following formula

(∫₀¹L(Rⱼ)·dx−∫₀¹Eq·dx)/∫₀¹Eq·dx.

In one embodiment, the Gini coefficients may also be modified by taking into account the splitting status and the Lorenz-Gini ratio. The splitting status of dataset D with respect to a kinase may be calculated using the following formula

$${split}_{A} ( D ) = 1 - {\sum }_{i = 1}^{m} {( \frac{\vert {R}_{i} \vert}{d} )}^{2} .$$

The LorenzGini value of D with respect to the attribute A may be defined by the following formula

Δgini(A)/split_{A}(D), where Δgini(A)=gini(D)−gini_{A}(D).

To further reduce the size of the kinase inferential bases and to improve the prediction accuracy, a Correlation-based Feature Selection (CFS) algorithm may be used to select smaller kinase inferential bases. This algorithm may be used to evaluate different combinations of kinases to identify an optimal subset. The kinase inferential bases to be evaluated may be generated using different subset search techniques. For example, Best First and Greedy search methods in the forward and backward directions, may be used. A Greedy search method considers changes local to the current subset through the addition or removal of kinases. For example, for a given parent set, a greedy search examines all possible child subsets through either the addition or removal of kinases. The child subset that shows the highest goodness measure then replaces the parent subset, and the process is repeated. The process terminates when no more improvement can be made.

A Best First search is similar to greedy search where it creates new subsets based on the addition or removal of kinases to the current subset. However, it has the ability to backtrack along the subset selection path to explore different possibilities when the current path no longer shows improvement. To prevent the search from backtracking through all possibilities in the kinase space, a limit may be placed on the number of non-improving subsets that are considered. In an embodiment of the present disclosure, a limit of five was chosen.

In one embodiment, in order to build the predictive model, a Bayesian Network (BayesNet), which is structured as a combination of a directed acyclic graph of nodes and links, and a set of conditional probability tables may be used. The directed acyclic graph has a node for each of the kinases and the class labels. Each node is associated with a color-coded table for the corresponding probability distribution related to the kinases. Nodes represent features or classes, while links between nodes represent the relationship between them. Conditional probability tables determine the strength of the links. There is one probability table for each node (feature) that defines the probability distribution for the node given its parent nodes. If a node has no parents the probability distribution is unconditional. If a node has one or more parents the probability distribution is a conditional distribution, where the probability of each feature value depends on the values of the parents. In this example, we discretized the binding affinities of drug inhibitors with each kinase to simplify the tables.

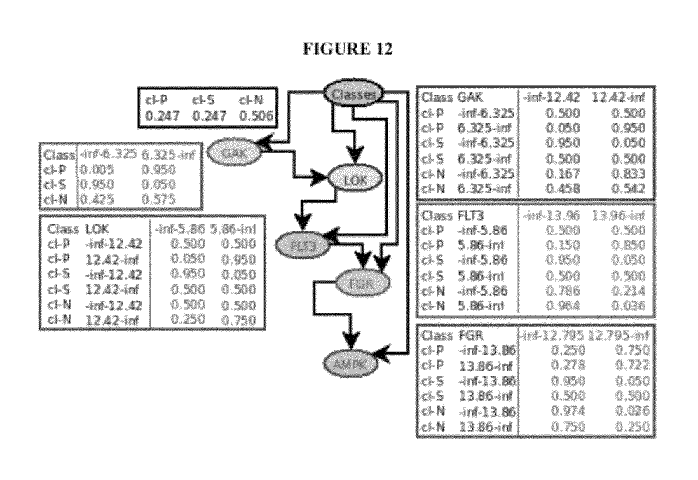

For example, the Bayesian network depicted in FIG. 12 is a predictive model for the selectivity of 37 kinase inhibitors when they are screened against 5 kinases GAK, LOK, FLT3 (D835H), FGR, and AMPK-α1. Once the predictive model is built, we can use the model to predict the selectivity of a drug inhibitor based upon the affinities with these five kinases. For instance, if the affinities of a drug inhibitor with these five kinases are 0, 0, 0, 0, and 0, the probabilities for this drug inhibitor to be classified as promiscuous is calculated as Pr[a_{GAK}=0,a_{FLT3}=0,a_{LOK}=0,a_{FGR}=0,a_{AMPK}=0, class=P]=Πᵢ₌₁⁵Pr[aᵢ|aᵢ's parents] Pr[class=P]=0.005·0.500·0.500·0.500·0.250·0.247=0.00004. Similarly, the probabilities for this drug inhibitor to be classified as selective, and neither of the two are 0.1911 and 0.0137, respectively. That said, this drug inhibitor is determined as selective. If the affinities of another drug inhibitor with these five kinases are 15, 15, 15, 15, and 15 the probabilities for this drug inhibitor to be classified as promiscuous, selective, and neither of the two are 0.12996, 0.00077, and 0.001.6, respectively. That said, this drug inhibitor is determined as promiscuous.

Each table has two parts separated by a vertical line. The left-hand side contains a column for each parent node. Each row on the right-hand side contains the probabilities that correspond to one combination of values of the parents. To construct an optimal Bayesian network, we need a method to evaluate the goodness of a given network based upon the data and a method to search through the space of possible networks. We used the Akaike Information Criterion (AIC), which is the negation of the log-likelihood plus the number of parameters (i.e. 6 in this example) as a measuring score for evaluating the quality of a network. To search for an optimal network, we start with a given ordering of kinases. We then process each node in turn and greedily consider adding edges that maximizes the network score. We also used other different searching strategies such as the Bayesian classification based method to compare the resulting networks. This searching method considers to add a second parent to each kinase. A prediction for which class the kinase inhibitor should be classified in is made based upon the probability scores calculated from the predictive model.

Once the kinase selectivity model has been used to select a kinase inferential bases, a k-fold cross validation may be used to test the accuracy of the kinase selectivity model. A k-fold cross validation is a common method for estimating the error of a model on some benchmark medical data sets. One reason for using this testing approach is because when a model is built from training data, the error on the training data may be rather optimistic estimate of the error rates the model will achieve on unseen data. As the aim of building a model is usually to apply the model to new, unseen data, such a k-fold cross validation is desirable. Another reason for using this testing approach is that the available kinase-inhibitor data sets are small and no test data set is available. It is well-known that k-fold cross-validation is very useful for this type of data sets.

For a reliable evaluation of the accuracy, the classification algorithm for many values of k may be tested. For example, tests for k=6, 7, 8, 9, and 10 may produce a reliable evaluation. In one embodiment, for each value of k, the data set D may be randomly divided into k subsets D₁, D₂, . . . , Dₖ. One of the subsets Dᵢ, i=1 . . . k may be left out each time for being used as a test data set for cross validation. The remaining subset U_{i≠i}Dⱼ may be used to build the model. The cross validation costs computed for each of the k test samples are then averaged to give the k-fold estimate of the cross validation costs. To ease the effects of the random partitions on the data set, this whole process is repeated 10 times and the results are then averaged again to give the estimated accuracy of the comparing algorithms. In some embodiments, it is unreasonable to use k≦5, because in those cases, the training datasets for building the models may not be big enough in comparison with the size of the testing data.

To facilitate a better understanding of the present disclosure, the following examples of certain aspects of some embodiments are given. In no way should the following examples be read to limit, or define, the entire scope of the invention.

### EXAMPLES

To validate a method of the present disclosure, data from a previous competition binding assays was used wherein 38 kinase inhibitors were evaluated against a panel of 287 distinct human protein kinases, three lipid kinases, and 27 disease-relevant mutant variants. The human protein kinases in the assay represent 55% of the predicted human protein kinome. The compounds tested included 21 tyrosine kinase inhibitors, 15 serine-threonine kinase inhibitors, and 1 lipid kinase inhibitor. Staurosporine was excluded from the selectivity analysis due to its obvious promiscuity but was used for testing the accuracy of the results. Each compound was screened against the panel of 317 assays at a single concentration of 10 μM to identify candidate kinase targets, and for each interaction observed in this primary screen a quantitative dissociation constant was determined.

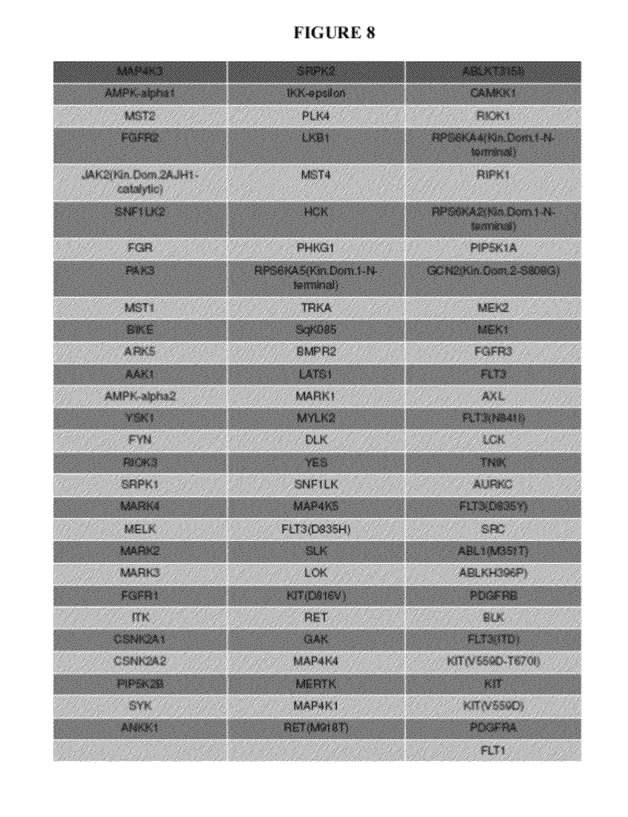

Using the methods described above, 85 highest ranking kinases were selected with respect to the GiniLorenz indexes. FIG. 8 contains a complete list of these 85 kinases. The CFS algorithm was then used to select a smaller subset of 11 kinases: MAP4K3, AMPK-alpha1, MST2, FGFR2, JAK2(Kin.Dom.2AJH1-catalytic), SNF1LK2, FGR, FLT3(D835H), LOK, GAK, and PDGFRB. After evaluating all possibilities of bases for this small subset of 11 kinases, a small inferential basis with five kinases was found: AMPK-alpha1, FGR, FLT3(D835H), LOK, GAK. The affinity interactions of kinase inhibitors with these five kinases gave a robust measure of specificity or promiscuity with 100% accuracy. All testing inhibitors were predicted correctly whether it is specific, promiscuous or none of those.

FIG. 3 shows that while this small inferential basis of five kinases predicted the specificity and promiscuity of kinase inhibitors with 100% accuracy, random sets of the same number of kinases gave an accuracy of approximately 52%.

Other small inferential bases of 5 kinases were found using the above methods, which included SLK, FGR, FLT3 (D835H), GAK and JAK2 and SLK, FGFR2, FLT3 (D835H), GAK and JAK2. The affinity interactions of kinase inhibitors with these two set of five kinases also gave a robust measure of specificity or promiscuity with 97.3% accuracy. Again, all inhibitors that were specific were correctly predicted, and all inhibitors that were promiscuous were correctly predicted. The only false prediction was a non-specific, non-promiscuous inhibitor that was falsely predicted as promiscuous.

Using the above methods, inferential bases with four kinases were also determined. Basis 4-1 consisted of FGFR2, GAK, LOK, and MAP4K5. The affinity interactions of kinase inhibitors with these four kinases give a robust measure of specificity or promiscuity with 97.3% accuracy. All inhibitors that is specific were correctly predicted, and all inhibitors that were promiscuous were correctly predicted. The only false prediction was a non-specific, non-promiscuous inhibitor that was falsely predicted as promiscuous.

Basis 4-2 consisted of FGR, FLT3(D835H), GAK, and LOK. The affinity interactions of kinase inhibitors with these four kinases also gave a robust measure of specificity or promiscuity with 97.3% accuracy. All inhibitors that were neither specific nor promiscuous were correctly predicted, and all inhibitors that were specific were correctly predicted. The only false prediction was a promiscuous inhibitor that was falsely predicted as non-specific, non-promiscuous.

Basis 4-3 consisted of AMPK-alpha1, FGR, GAK, and LOK. The affinity interactions of kinase inhibitors with these four kinases also gave a robust measure of specificity or promiscuity with 97.3% accuracy. All inhibitors that were specific were correctly predicted, and all inhibitors that were promiscuous were correctly predicted. The only false prediction was a non-specific, non-promiscuous inhibitor that was falsely predicted as specific.

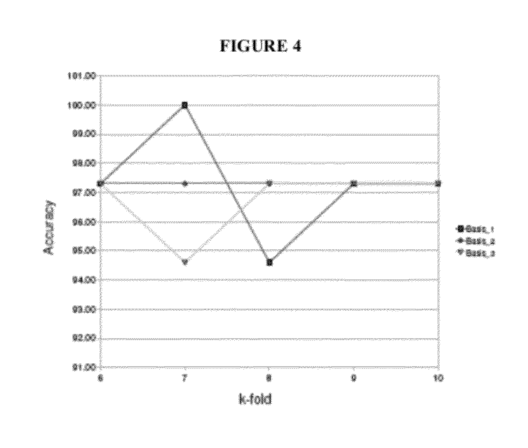

FIG. 4 shows the accuracy of these small inferential basis with four kinases in predicting the specificity and promiscuity of kinase inhibitors under different k-fold validation schemes.

Using the above methods, inferential bases with three kinases were also determined. Basis 3-1 consisted of GAK, LOK, and MAP4K5. The affinity interactions of kinase inhibitors with these three kinases also gave a robust measure of specificity or promiscuity with 97.3% accuracy. All inhibitors that were specific were correctly predicted, and all inhibitors that were promiscuous were correctly predicted. The only false prediction was a nonspecific, non-promiscuous inhibitor that was falsely predicted as promiscuous.

Basis 3-2 consisted of FGFR2, GAK, and LOK. The affinity interactions of kinase inhibitors with these three kinases also gave a robust measure of specificity or promiscuity with 91.9% accuracy. Again, all inhibitors that were specific were correctly predicted, and all inhibitors that were promiscuous were correctly predicted. Only 1 out of 19 inhibitors that was neither specific nor promiscuous was falsely predicted as specific. Only 2 out of 19 inhibitors that was neither specific nor promiscuous were falsely predicted as promiscuous.

Basis 3-3 consisted of FGFR2, GAK, and MAP4K5. The affinity interactions of kinase inhibitors with these three kinases also give a robust measure of specificity or promiscuity with 91.9% accuracy. Again, all inhibitors that were specific were correctly predicted, and all inhibitors that were promiscuous were correctly predicted. Only 3 out of 19 inhibitors that were neither specific nor promiscuous were falsely predicted as specific.

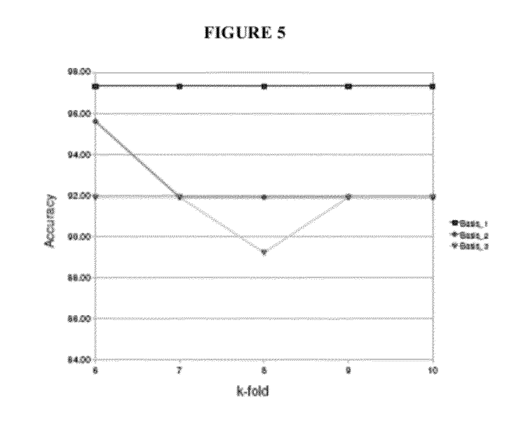

FIG. 5 shows the accuracy of these small inferential basis with three kinases in predicting the specificity and promiscuity of kinase inhibitors under different k-fold validation schemes.

Using the above methods, inferential bases with two kinases were also determined. The two kinase bases consisted of GAK, and MAP4K5. This two kinase bases gave a robust measure of specificity or promiscuity with 89.2% accuracy. All inhibitors that were specific were correctly predicted, and all inhibitors that were promiscuous were correctly predicted. Only 3 out of 19 inhibitors that were neither specific nor promiscuous were falsely predicted as specific. Only 1 out of 19 inhibitors that was neither specific nor promiscuous was falsely predicted as promiscuous. FIG. 6A shows the accuracy of this small inferential basis with two kinases in predicting the specificity and promiscuity of kinase inhibitors under different k-fold validation schemes. It is very interesting that the small inferential basis of just two kinases GAK and MAP4K5 gave a measure of specificity or promiscuity that is more accurate than what near full sets of 300 kinases can give, as depicted in FIG. 6B.

Thus, it has been demonstrated that the above process is a novel method for quantitative analyses of kinase inhibitor selectivity together with the very small size inferential bases for predicting the promiscuity or specificity of kinase inhibitors in cancer drug design. These crucial inferences do not require kinome-wide screening of a new drug against all 500+ kinases but are rather determined by a few specific hits with 100% accuracy. Hence, the new method can help to save >90% of the screening costs for drugs.

Therefore, the present disclosure is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces. If there is any conflict in the usages of a word or term in this specification and one or more patent or other documents that may be incorporated herein by reference, the definitions that are consistent with this specification should be adopted.

### REFERENCES

1. Statistical Learning Theory. Wiley-Interscience, 1998.
2. Information Theory, Inference, and Learning Algorithms. Cambridge University Press, 2003.
3. Data Mining: Practicial Machine Learning Tools and Techniques. Morgan Kaufmann, 2008.
4. J. Dancy and E. A. Sausville. Issues and Progress with Protein Kinase Inhibitors for Cancer Treatment. Nat. Rev. Drug Discov., 2:296-313, 2003.
5. M. Fabian, W. Biggs, D. Treiber, C. Atteridge, M. Azimioara, M. Benedetti, T. Carter, P. Ciceri, P. Edeen, M. Floyd, J. Ford, M. Galvin, J. Gerlach, R. Grotzfeld, S. Herrgard, D. Insko, M. Insko, A. Lai, J. Lelias, S. Mehta, Z. Milanov, A. Velasco, L. Wodicka, H. Patel, P. Zarrinkar, and D. Lockhart. A small molecule-kinase interaction map for clinical kinase inhibitors. Nat. Biotech., 23:329-366, 2005.
6. S. Frantz. Drug discovery: playing dirty. Nature, 437:942-943, 2005.
7. K. Ghoreschi, A. Laurence, and J. J. O'Shea. Selectivity and therapeutic inhibition of kinases: to be or not to be? Nat Immunol, 10(4):356-360, April 2009.
8. T. Hampton. “Promiscuous” anticancer drugs that hit multiple targets may thwart resistance. JAMA, 292:419-422, 2004.
9. A. Hopkins, J. Mason, and J. Overington. Can we rationally design promiscuous drugs? Curr. Opin. Struct. Biol., 16:127-136, 2006.
10. P. Janne, N. Gray, and J. Settleman. Factors underlying sensitivity of cancers to smalimolecule kinase inhibitors. Nat Rev Drug Discov., 8(9):709-723, 2009.
11. M. W. Karaman, S. Herrgard, D. K. Treiber, P. Gallant, C. E. Atteridge, B. T. Campbell, K. W. Chan, P. Ciceri, M. I. Davis, P. T. Edeen, R. Faraoni, M. Floyd, J. P. Hunt, D. J. Lockhart, Z. V. Milanov, M. J. Morrison, G. Pallares, H. K. Patel, S. Pritchard, L. M. Wodicka, and P. P. Zarrinkar. A quantitative analysis of kinase inhibitor selectivity. Nat Biotech, 26(1):127-132, January 2008.
12. C. Keith, A. Borisy, and B. Stockwell. Multicomponent therapeutics for networked systems. Nat. Rev. Drug. Discov., 4:71-78, 2005.
13. A. Levitski and A. Gazit. Tyrosine kinase inhibition: an approach to drug development. Science, 267:1782-1788, 1995.
14. S. K. Mencher and L. G. Wang. Promiscuous drugs compared to selective drugs (promiscuity can be a virtue). BMC Clin. Pharmacol., 5:3-9, 2005.
15. B. Roth, D. Sheffler, and W. Kroeze. Magic shotguns versus magic bullets: selectively non-selective drugs for mood disorders and schizophrenia. Nat. Rev. Drug Discov., 3:353-359, 2004.
16. R. Tibes, J. Trent, and R. Kurzrock. Tyrosine kinase inhibitors and the dawn of molecular cancer therapeutics. Annu. Rev. Pharmacol. Toxicol., 45:357-384, 2005.
17. B. Vogelstein and K. Kinzler. Cancer genes and the pathways they control. Nature Medicine, 10:789-799, 2004.
18. J. Zhang, P. Yang, and N. Gray. Targeting cancer with small molecule kinase inhibitors. Nat Rev Cancer, 9(1):28-39, 2009.
19. Tran, Q.-N. Mining medical databases with modified Gini index classification. In Proceedings of IEEE-ITNG 2008 Conference (IEEE, Las Vegas, Nev., 2008).
20. Tran, Q.-N. Microarray data mining: A new algorithm for gene selection using Gini ratios. In Proceedings of IEEE-ITNG 2010 Conference (Las Vegas, Nev., 2010).

What is claimed is:

1. A method comprising: providing a set of kinases, ranking the kinases based upon their ability to overcome biases, utilizing a correlation-based feature selection algorithm to select a kinase inferential bases, and screening a kinase inhibitor against the kinase inferential bases.

2. A method comprising: screening a kinase inhibitor against a kinase inferential bases.

3. A method for determining a kinase inferential bases comprising: providing a set of kinases, ranking the kinases based upon their ability to overcome biases, and utilizing a correlation-based feature selection algorithm to select a kinase inferential bases.
